(19) United States
(12) Patent Application Publication
(10) Pub. No.: US 2014/0161501 A1
(43) Pub. Date: Jun. 12, 2014

(54) IMAGE FORMING DEVICE

(71) Applicants: Kazuhiko Watanabe, Tokyo (JP); Takatsugu Fujishiro, Tokyo (JP); Takaaki Tawada, Kanagawa (JP); Hisashi Kikuchi, Kanagawa (JP)

(72) Inventors: Kazuhiko Watanabe, Tokyo (JP); Takatsugu Fujishiro, Tokyo (JP); Takaaki Tawada, Kanagawa (JP); Hisashi Kikuchi, Kanagawa (JP)

(73) Assignee: RICOH COMPANY, LTD., Tokyo (JP)

(21) Appl. No.: 14/102,391

(22) Filed: Dec. 10, 2013

(30) Foreign Application Priority Data
Dec. 11, 2012 (JP) 2012-270609

(51) Int. Cl. G03G 21/00

(52) U.S. Cl. CPC G03G 15/01
USPC 399/346; 399/350

(57) ABSTRACT

In an image forming device, an image formation unit operated in a monochrome mode includes a lubricant applying unit and a charging device to supply a DC voltage superimposed with an AC voltage to an image carrier, and each of image formation units operated only in a color mode includes a charging device to supply a DC voltage to an image carrier, and one of the image formation units arranged on a downstream side of the image formation unit operated in the monochrome mode in a moving direction of an intermediate transfer member includes a cleaning device having a blade member in which a proximal edge portion contacts the image carrier to remove residual toner from the image carrier, and the proximal edge portion is made of an elastic rubber having a 100% modulus value of 6 MPa or greater at 23° C.

### CROSS-REFERENCE TO RELATED APPLICATIONS

This patent application is based on and claims priority pursuant to 35 U.S.C. §119 to Japanese Patent Application No. 2012-270609, filed on Dec. 11, 2012, the entire disclosure of which is hereby incorporated by reference herein.

### BACKGROUND OF THE INVENTION

1. Field of the Invention

The present invention relates to an image forming device, such as a copier, a facsimile machine, and a printer.

2. Description of the Related Art

A tandem image forming device is known as an image forming device including plural image formation units. Each of the image formation units includes a photoconductor (which serves as an image carrier), a charging device, a developing device, a cleaning device, etc. In the tandem image forming device, the plural image formation units are arranged in parallel along an intermediate transfer belt. This image forming device is capable of operating in one of a color mode and a monochrome mode. In the color mode, the plural image formation units are activated to generate respective color toner images and a color image is formed by superimposing the color toner images. In the monochrome mode, only a single image formation unit is activated to form a monochrome image. Generally, in office environments, the demands for image formation in the monochrome mode are much greater than the demands for image formation in the color mode, and the frequency of use of the photoconductor used in the monochrome mode among the photoconductors of the image formation units in the tandem image forming device remarkably increases.

As a charging device of the image formation unit, a charging device utilizing a charging component, such as a charging roller, which generates ozone in an amount smaller than that of a corona-discharge type charging device, is more popular. Among the charging devices utilizing the charging roller, there are two types: one supplying a DC (direct current) voltage to the image carrier via the charging roller, and the other supplying a DC voltage superimposed with an AC (alternating current) voltage to the image carrier via the charging roller. Because the charging devices of the AC superimposed voltage type provide better charge uniformity than the charging devices of the DC voltage type, the former is often used so as to pursue high image quality.

However, when compared with the DC voltage type, the AC superimposed voltage type requires a high charging current flowing through a photoconductor, and the photoconductor surface layer may easily deteriorate and wear of the photoconductor may be easily promoted by the parts contacting the photoconductor surface. Further, when compared with the DC voltage type, the AC superimposed voltage type produces a relatively large amount of ozone and much discharge products. If these substances adhere to the photoconductor surface and generate the occurrence of toner filming, it may be the cause of deterioration of image quality.

For example, Japanese Laid-Open Patent Publication Nos. 2001-109332 and 2002-156806 disclose an image forming device including plural image formation units. Each of the image formation units includes a charging roller as a charging device, and a power supply. The image forming device is adapted to selectively supply one of a DC voltage and an AC superimposed voltage from the power supply to the charging rollers of the image formation units. When a request for image formation in a monochrome mode is received, the DC voltage is supplied from the power supply to the charging roller of the image formation unit used in the monochrome mode. When a request for image formation in a color mode is received, the AC superimposed voltage is supplied from the power supply to the charging rollers of the image formation units. In this image forming device, deterioration of image quality due to wear and filming of the photoconductor used in the monochrome mode is prevented while high image quality in the color mode is pursued.

To prevent the wear and filming of the photoconductor, a method of utilizing a lubricant applying unit to apply a lubricant to the photoconductor surface has been proposed.

On the other hand, as a cleaning device of an image formation unit, a blade type cleaning device which scrapes off foreign matter adhering to the photoconductor surface with a cleaning blade of an elastic material has been proposed. In this respect, a cleaning blade including a portion brought in contact with the photoconductor surface and the portion made of an elastic material having a 100% modulus value of 6 MPa or greater at a temperature of 23° C. is known. This cleaning blade may provide good cleaning performance by stabilizing the action of the portion in contact with the photoconductor surface. See Japanese Laid-Open Patent Publication Nos. 2011-197309 and 2011-197311.

In the charging device in which the AC superimposed voltage is supplied to the charging roller, charging sound occurs due to the presence of the AC. In the case of the image forming device disclosed in Japanese Laid-Open Patent Publication Nos. 2011-197309 and 2011-197311, when the image forming device operates in the color mode, the AC superimposed voltage is supplied to all of the image formation units simultaneously, and the charging sound becomes loud and may turn into unusual noise. In addition, when the image forming device operates in the color mode, the AC superimposed voltage is supplied to all of the image formation units, and the amount of ozone emerging from the image forming device increases.

### SUMMARY OF THE INVENTION

In one aspect, the present invention provides an image forming device which has good reliability and a long operating life and is capable of preventing the device enlargement and weight increase while taking into consideration the office environments.

In an embodiment which solves or reduces one or more of the above-mentioned problems, the present invention provides an image forming device including a plurality of image formation units, each of the plurality of image formation units including an image carrier, a charging device to charge a surface of the image carrier, a developing device to form a toner image on the image carrier surface, and a cleaning device to remove residual toner on the image carrier surface, wherein the plurality of image formation units are arranged in a line in a vicinity of an intermediate transfer member and transfer the toner image formed on the image carrier to a recording medium via the intermediate transfer member, wherein the image forming device selectively operates in one of a color mode in which the plurality of image formation units are operated to form a color image and a monochrome mode in which a single image formation unit is operated to form a monochrome image, wherein the image formation unit operated in the monochrome mode includes a lubricant applying unit to apply a lubricant to the image carrier and the charging device to supply a DC voltage superimposed with an AC voltage to the image carrier, wherein each of the image formation units operated only in the color mode includes the charging device to supply a DC voltage to the image carrier, and one of the image formation units arranged at a position nearest to and on a downstream side of the image formation unit operated in the monochrome mode in a moving direction of the intermediate transfer member includes the cleaning device having a blade member in which a proximal edge portion of the blade member contacts the image carrier surface to remove residual toner from the image carrier surface, and the proximal edge portion of the blade member is made of an elastic rubber having a 100% modulus value of 6 MPa or greater at 23° C.

Other objects, features and advantages of the present invention will become more apparent from the following detailed description when read in conjunction with the accompanying drawings.

### BRIEF DESCRIPTION OF THE DRAWINGS

FIG. 1 is a schematic diagram showing a structure of a printer according to an embodiment.

FIG. 2 is a schematic diagram showing a structure of a black toner process cartridge provided in the printer according to the embodiment.

FIG. 3 is a schematic diagram showing a structure of a color toner process cartridge provided in the printer according to the embodiment.

FIG. 4 is a schematic diagram showing a structure of a cleaning blade provided in the color toner process cartridge.

FIG. 5 is a schematic diagram showing a structure of a printer according to the related art.

FIG. 6 is a schematic diagram showing a structure of a process cartridge provided in the printer according to the related art.

### DETAILED DESCRIPTION OF THE PREFERRED EMBODIMENTS

A description will be given of embodiments of the invention with reference to the accompanying drawings.

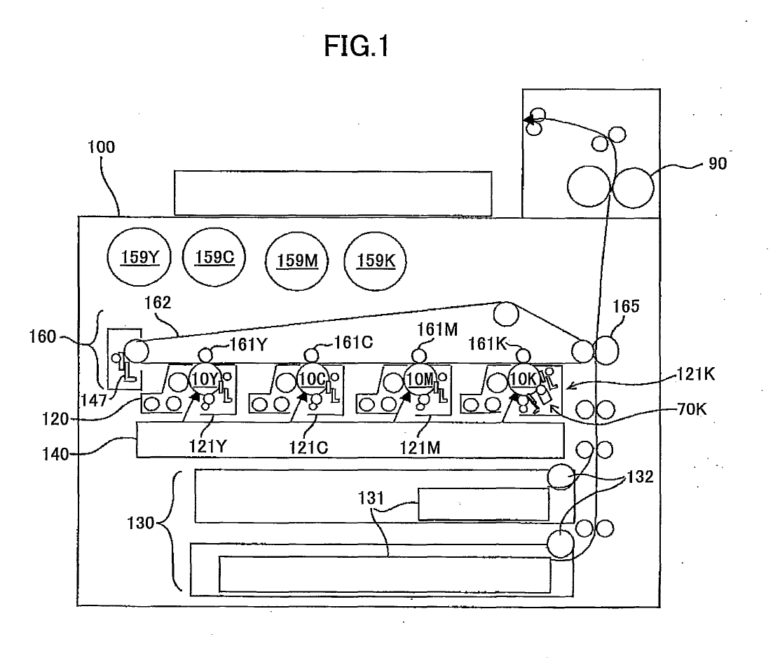

FIG. 1 is a schematic diagram showing a structure of a printer 100 which is an image forming device according to an embodiment. The printer 100 forms a full-color image and includes an image formation module 120, an intermediate transfer device 160, and a sheet feeding module 130. In the following description, suffixes Y, C, M, and K represent members or components for yellow, cyan, magenta, and black colors, respectively.

The image formation module 120 includes a yellow (Y) process cartridge 121Y, a cyan (C) process cartridge 121C, a magenta (M) process cartridge 121M, and a black (K) process cartridge 121K, which are arranged in this order from the left-hand side of the drawing. These process cartridges 121Y, 121C, 121M, and 121K (which may be collectively referred to as the process cartridges 121) are arranged in a line in a substantially horizontal direction. Hence, the printer 100 is the tandem image forming device described above. The process cartridges 121Y, 121C, 121M, and 121K include drum-like photoconductors 10Y, 10C, 10M, and 10K (which may be collectively referred to as the photoconductors 10), respectively, each photoconductor serving as a latent image carrier, which is an image carrier having a moving surface.

The intermediate transfer device 160 generally includes a circulating intermediate transfer belt 162 (which is an intermediate transfer member stretched over multiple support rollers), primary transfer rollers 161Y, 161C, 161M, and 161K (which may be collectively referred to as the primary transfer rollers 161), and a secondary transfer roller 165. The intermediate transfer belt 162 is provided above the process cartridges 121, and extends along the moving direction of the respective surfaces of the photoconductors 10. A surface of the intermediate transfer belt 162 moves in synchronization with the movement of the respective surfaces of the photoconductors 10. Moreover, the primary transfer rollers 161 are arranged on the side of the inner circumferential surface of the intermediate transfer belt 162. The primary transfer rollers 161 bring the lower side of the outer circumferential surface (i.e., outer surface) of the intermediate transfer belt 162 into low pressure contact with the outer circumferential surface (i.e., outer surface) of each of the photoconductors 10.

Each of the process cartridges 121 forms a toner image on a corresponding one of the photoconductors 10 and transfers the toner image to the intermediate transfer belt 162. Among the process cartridges 121Y, 121C, 121M, and 121K arranged in a line in the substantially horizontal direction, the K process cartridge 121K is disposed at a right-hand end position (i.e., a most downstream position among the four process cartridges) with respect to the moving direction of the intermediate transfer belt 162. The primary transfer rollers 161Y, 161C, and 161M corresponding to three color process cartridges 121Y, 121C, and 121M are provided with a swing mechanism (not illustrated) which vertically swings the primary transfer rollers 161Y, 161C, and 161M. The swing mechanism operates to prevent the intermediate transfer belt 162 from coming in contact with the photoconductors 10Y, 10C, and 10M when a color image is not to be formed.

The intermediate transfer device 160 which serves as an intermediate transfer unit is removably attached to the body of the printer 100. Specifically, if a front cover (not illustrated) provided on the near side of FIG. 1 to cover the image formation module 120 of the printer 100 is opened and the intermediate transfer device 160 is slid from the far side toward the near side of FIG. 1, the intermediate transfer device 160 can be detached from the body of the printer 100. To attach the intermediate transfer device 160 to the body of the printer 100, an operation reverse to the detaching operation is performed.

At a position on the intermediate transfer belt 162 downstream of the secondary transfer roller 165 and upstream of the process cartridge 121Y with respect to the moving direction of the surface of the intermediate transfer belt 162, an intermediate transfer belt cleaning device 147 is disposed to remove foreign matter, such as residual toner remaining after the secondary transfer operation and adhering to the intermediate transfer belt 162. The intermediate transfer belt cleaning device 147 supported integrally with the intermediate transfer belt 162 is removably attached to the body of the printer 100 as a part of the intermediate transfer device 160.

Above the intermediate transfer device 160, toner cartridges 159Y, 159C, 159M, and 159K corresponding to the process cartridges 121Y, 121C, 121M, and 121K, respectively, are arranged in a line in a substantially horizontal direction. Below the process cartridges 121Y, 121C, 121M, and 121K, an exposure device 140 is arranged, and this exposure device 140 applies laser light to the charged surface of each of the photoconductors 10Y, 10C, 10M, and 10K to form an electrostatic latent image thereon. Below the exposure device 140, the sheet feeding module 130 is arranged.

The sheet feeding module 130 includes a sheet feeding cassettes 131 for storing transfer sheets serving as recording medium and sheet feeding rollers 132. The sheet feeding module 130 feeds each transfer sheet at predetermined timing toward a secondary transfer nip portion which is formed between the intermediate transfer belt 162 and the secondary transfer roller 165 through a registration roller pair. A fixing device 90 is arranged at a position on the downstream side of the secondary transfer nip portion in the transfer-sheet transporting direction. Further, at a position on the downstream side of the fixing device 90 in the transfer-sheet transporting direction, sheet discharging rollers and a discharged sheet storing unit for storing discharged transfer sheets are arranged.

In the printer 100 according to the embodiment, the K process cartridge 121K among the process cartridges 121Y, 121C, 121M, and 121K is arranged at a position nearest to the secondary transfer nip portion and on the upstream side of the secondary transfer nip portion. Hence, the distance of the K process cartridge 121K to the transfer-sheet transporting passage is shortened, and the printing speed in the monochrome mode is increased. In the printer 100 according to the embodiment, the K process cartridge 121K and the three color process cartridges 121Y, 121C, and 121M have mutually different structures which will be described below.

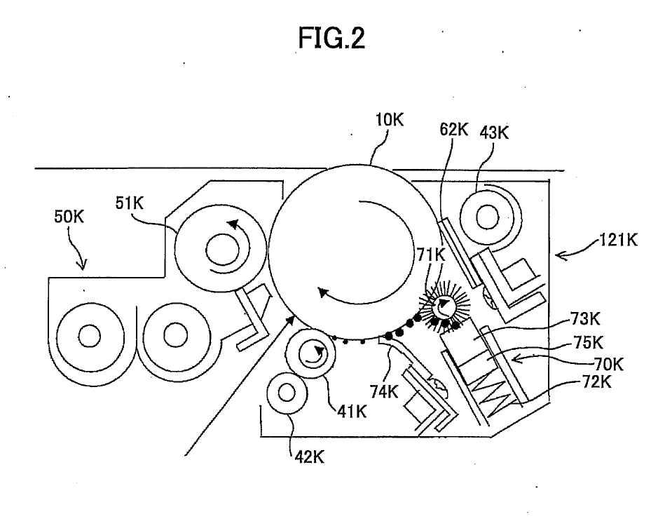

FIG. 2 is a schematic diagram showing a structure of the black (K) process cartridge 121K provided in the printer 100. As shown in FIG. 2, the process cartridge 121K includes the photoconductor 10K, and a cleaning device 30K, a charging device 40K, a developing device 50K, and a lubricant applying unit 70K which are arranged around the photoconductor 10K. The charging device 40K includes a charging roller 41K and a charging roller cleaner 42K which is in contact with and rotated by the charging roller 41K. The charging roller 41K is made of a conductive rubber layer formed on a core metal. A DC voltage superimposed with an AC voltage (which will be called the AC superimposed voltage) is supplied to the photoconductor 10K via the charging roller 41K. By supplying the AC superimposed voltage to the charging roller 41K, the charging uniformity is increased in spite of the toner adhering to the charging roller 41K and good charging performance is provided for the photoconductor 10K. When the linear velocity of the photoconductor 10K is increased, the charging stability is maintained.

The developing device 50K includes a developing roller 51K which serves as a developer carrier. A developing bias is supplied from a power supply (which is not illustrated) to the developing roller 51K. In a casing of the developing device 50K, a supplying screw and a mixing screw are arranged. The mixing screw conveys the developer contained in the casing while mixing the developer. The supplying screw conveys the mixed developer while supplying the developer to the developing roller 51K. Further, a doctor for regulating the developer carried by the developing roller 51K is also arranged. The toner in the developer mixed and conveyed by the supplying screw and the mixing screw is charged in a predetermined polarity. The developer is attracted to the surface of the developing roller 51K, the attracted developer is regulated by the doctor, and the toner in a development region of the developing roller 51K which confronts the photoconductor 10K adheres to a latent image on the photoconductor 10K.

The cleaning device 30K includes a cleaning blade 62K, a recovery screw 43K, etc. The cleaning blade 62K extends in a counter direction opposite to the moving direction of the surface of the photoconductor 10 and is in contact with the photoconductor 10K. The residual toner which remains on the surface of the photoconductor 10K after the toner image is transferred to the intermediate transfer belt 162 is removed by the cleaning blade 62K. The toner removed from the photoconductor surface by the cleaning blade 62K is conveyed to a waste toner container (which is not illustrated) by the recovery screw 43K. The structure of the cleaning blade 62K will be described later.

A lubricant applying unit 70K includes a lubricant pressurizing spring 72K, a solid lubricant 73K, etc. The lubricant applying unit 70K uses a fur brush 71K as an application brush to apply the solid lubricant 73K to the photoconductor 10. The solid lubricant 73K is held on a bracket 75K, and pressed toward the side of the fur brush 71K by the lubricant pressurizing spring 72K. The solid lubricant 73K is shaved by the fur brush 71K which is rotated in a direction opposite to the rotating direction the photoconductor 10K, and such lubricant is applied to the surface of the photoconductor 10K. A leveling blade 74K is supported in contact with the surface of the photoconductor 10K and pressed onto the surface of the photoconductor 10K in a fixed manner. The lubricant removed from the solid lubricant 73K in a powder state is applied to the surface of the photoconductor 10K by the fur brush 71K and the lubricant adhering onto the surface of the photoconductor 10K is leveled by the leveling blade 74K. By using the lubricant applying unit 70K, the photoconductor surface can be protected from the attacking action of the AC current of the charging roller 41K, and the operating life of the process cartridge 121K can be prevented from being shortened.

The solid lubricant 73K contains a fatty-acid metal salt (A) and an inorganic lubricant (B). The fatty-acid metal salt (A) which is ruptured by the charging current serves to prevent the photoconductor surface from being ruptured, and at the same time the inorganic lubricant (B) which is not ruptured by the charging current serves to maintain the lubricating action in a suitable state (which is more suitable than in a case of a lubricant containing only the fatty-acid metal salt). This enables the cleaning performance of the photoconductor 10K to be maintained at a desired level.

Examples of the fatty-acid metal salt (A) include barium stearate, lead stearate, iron stearate, nickel stearate, cobalt stearate, copper stearate, strontium stearate, calcium stearate, cadmium stearate, magnesium stearate, zinc stearate, zinc oleate, magnesium oleate, iron oleate, cobalt oleate, copper oleate, lead oleate, manganese oleate, zinc palmitate, cobalt palmitate, lead palmitate, magnesium palmitate, aluminum palmitate, calcium palmitate, lead caprylate, lead caprate, zinc linoleate, cobalt linoleate, calcium linoleate, zinc ricinoleate, cadmium ricinoleate, and a mixture thereof. However, the fatty-acid metal salt (A) according to the invention is not limited to these examples. Any mixture of these examples may be used instead. In this embodiment, it is preferred to use zinc stearate as the fatty-acid metal salt (A), which is especially excellent in the ability of film formation on the photoconductor 10 among the above examples.

The inorganic lubricant (B) is an inorganic compound which cleaves to provide lubricity or internal slipperiness. Examples of the inorganic lubricant (B) include talc, mica, boron nitride, molybdenum disulfide, tungsten disulfide, kaolin, smectite, hydrotalcite compounds, calcium fluoride, graphite, slab-like alumina, sericite, synthetic mica, etc. However, the inorganic lubricant (B) according to the invention is not limited to these examples. In this embodiment, it is preferred to use boron nitride among these examples, which easily cleaves to provide lubricity. To add a hydrophobic property, the inorganic lubricant may be subjected to a surface treatment if needed.

By applying the lubricant to the photoconductor surface of K color using the lubricant applying unit 70K, the photoconductor surface can be protected from the attacking action of the AC current of the charging roller 41K. Moreover, the photoconductor cleaning performance can be improved and the toner transferring characteristics can be improved. To stabilize the application of the lubricant, the lubricant applying unit 70K is arranged at a position on the downstream side of the cleaning blade 62K in the rotating direction of the photoconductor. The charging uniformity is increased in spite of the toner adhering to the charging roller 41K and good charging performance is provided for the charging roller 41K by supplying the AC superimposed voltage to the charging roller 41K. However, by taking into consideration the stain on the charging roller 41K, the charging roller 41K may be arranged to confront the photoconductor 10K with a minute gap between the charging roller 41K and the photoconductor 10K. On the contrary, the charging roller 41K may be arranged to be in contact with the photoconductor 10K so that the charging current is increased to stabilize the charging characteristics. In such a case, high image quality and a longer operating life of the K process cartridge 121K may be provided.

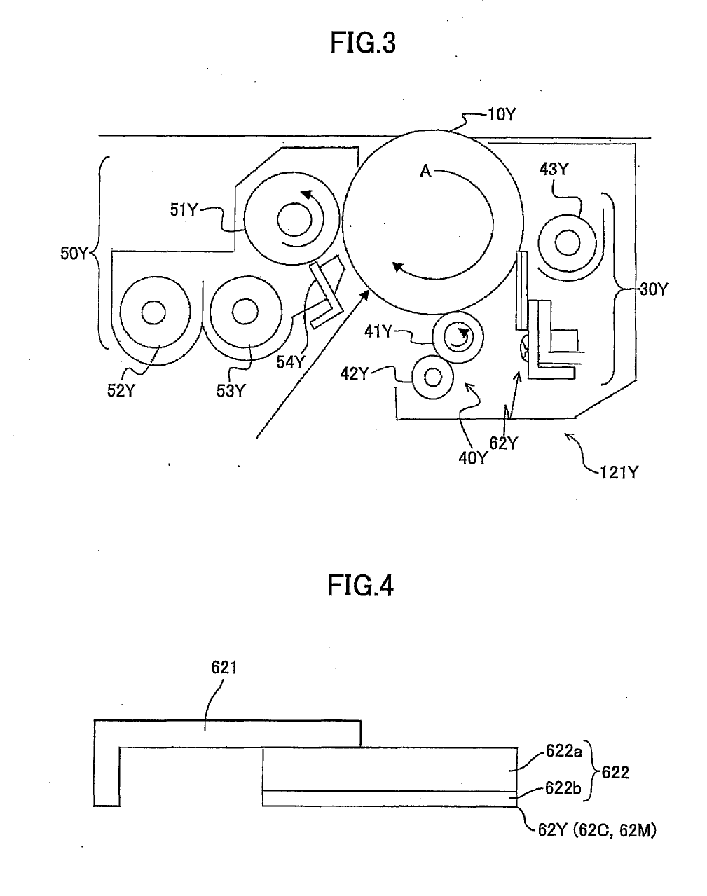

FIG. 3 is a schematic diagram showing a structure of a yellow process cartridge 121Y provided in the printer 100 according to the embodiment. Here, the composition of each of the color toner process cartridges 121Y, 121C, and 121M is essentially the same. Hence, in the following, the composition and operation of the process cartridge 121Y as a typical color toner process cartridge will be described.

As shown in FIG. 3, the process cartridge 121Y includes the photoconductor 10Y, and a cleaning device 30Y, a charging device 40Y, and a developing device 50Y which are arranged around the photoconductor 10Y.

The charging device 40Y includes a charging roller 41Y arranged to be in contact with the photoconductor 10Y, and a charging roller cleaner 42Y which is in contact with and rotated by the charging roller 41Y. The charging roller 41Y is made of a conductive rubber layer formed on a core metal. A DC voltage is supplied to the photoconductor 10Y via the charging roller 41Y. By supplying the DC voltage to the photoconductor 10Y, the load on the photoconductor 10Y is reduced, the wear and filming of the photoconductor 10 are reduced, and a long operating life can be provided for the photoconductor 10Y.

The composition of the developing device 50Y is essentially the same as that of the K developing device 50K except that the colors of the toners stored therein differ from each other, and a description thereof will be omitted.

The cleaning device 30Y includes a cleaning blade 62Y, a recovery screw 43Y, etc. The cleaning blade 62Y extends in a counter direction opposite to the moving direction of the surface of the photoconductor 10Y and is in contact with the photoconductor 10Y. The residual toner which remains on the surface of the photoconductor 10Y after the toner image is transferred to the intermediate transfer belt 162 is removed by the cleaning blade 62Y. The toner removed from the photoconductor surface by the cleaning blade 62Y is conveyed to a waste toner container (not illustrated) by the recovery screw 43Y. The composition of the cleaning blade 62Y will be described later.

In the process cartridge 121Y, the charging roller 41Y to which only the DC voltage is supplied is used, and it is not necessary to apply a lubricant to the photoconductor 10Y in order to prevent the wear and filming of the photoconductor 10Y from occurring due to the application of the AC superimposed voltage. Hence, the lubricant adhering to the charging roller 41Y can be eliminated.

Each of the four process cartridges 121 as described above may be independently attached, detached, and exchanged by a service person or a user. Further, in the process cartridge 121 detached from the printer 100, each of the photoconductor 10, the charging device 40, the developing device 50, and the cleaning device 30 may be independently exchanged with a new replacement device. The process cartridge 121 may include a waste toner tank for collecting the remaining toner after the transferring of the toner image by the cleaning device 30. In this case, if the process cartridge 121 allows the waste toner tank to be independently attached, detached, and exchanged, convenience is improved.

Next, the operation of the printer 100 according to the embodiment will be described. Upon receipt of a print instruction from an external device, such as an operation panel or personal computer (not illustrated), the printer 100 selects one of a color mode and a monochrome mode.

In the color mode, the swing mechanism is caused to lower the primary transfer rollers 161Y, 161C, and 161M corresponding to the three color process cartridges 121Y, 121C, and 121M so that the intermediate transfer belt 162 is in contact with the photoconductors 10Y, 10C, and 10M. In each of the process cartridges 121Y, 121C, 121M, and 121K, the photoconductor 10 is rotated in a direction indicated by the arrow A in FIG. 3, and the surface of the photoconductor 10 is uniformly charged to a predetermined polarity by the charging roller 41 of the charging device 40. The exposure device 140 applies laser beams for the respective colors, optically modulated in accordance with input color image data, to the respective charged surfaces of the photoconductors 10, so that electrostatic latent images corresponding to the respective colors are formed on the respective surfaces of the photoconductors 10. Each of the electrostatic latent images is supplied with a developer of the corresponding color from the developing roller 51 of the developing device 50 for the color. Thereby, the electrostatic latent images corresponding to the respective colors are developed by the developers of the respective colors and visualized as toner images corresponding to the respective colors.

Subsequently, the primary transfer rollers 161 are supplied with a transfer voltage opposite in polarity to the toner images. Thereby, a primary transfer electric field is formed between the photoconductors 10 and the primary transfer rollers 161 through the intermediate transfer belt 162. Further, the primary transfer rollers 161 bring the intermediate transfer belt 162 into low pressure contact with the photoconductors 10 to form respective primary transfer nip portions. Due to the above-described functions, the respective toner images on the photoconductors 10 are efficiently primarily transferred onto the intermediate transfer belt 162. As a result, the toner images of the respective colors formed on the photoconductors 10 are transferred onto the intermediate transfer belt 162 to be superimposed on one another, and a laminated toner image is formed.

On the other hand, a transfer sheet stored in one of the sheet feeding cassettes 131 is fed at predetermined timing by the corresponding sheet feeding roller 132, the registration roller pair, and so on. Then, a transfer voltage opposite in polarity to the laminated toner image primarily transferred onto the intermediate transfer belt 162 is applied to the secondary transfer roller 165, so that a secondary transfer electric field is formed between the intermediate transfer belt 162 and the secondary transfer roller 165 through the transfer sheet by which the laminated toner image is transferred onto the transfer sheet. The transfer sheet having the laminated toner image transferred thereto is then conveyed to the fixing device 90, and the toner image is fixed on the transfer sheet with heat and pressure. The transfer sheet having the toner image fixed thereon is discharged to and placed on the discharged sheet storing unit by the sheet discharging rollers. On the other hand, the residual toner remaining on each of the photoconductors 10 after the primary transfer operation is scraped off and removed by the blade member of the corresponding cleaning device 30.

Meanwhile, when the monochrome mode is selected, the swing mechanism is caused to lift the primary transfer rollers 161Y, 161C, and 161M corresponding to the three color process cartridges 121Y, 121C, and 121M to prevent the intermediate transfer belt 162 from contacting the photoconductors 10Y, 10C, and 10M. In this case, as described above, only the K process cartridge 121K is operated and a black toner image is formed on the photoconductor 10K. Subsequently, the black toner image on the photoconductor 10K is transferred onto the intermediate transfer belt 162, and further transferred onto the transfer sheet by the secondary transfer roller 165.

Next, the cleaning blade 62 will be described. FIG. 4 is a schematic diagram showing a structure of the cleaning blade 62Y provided in the Y process cartridge 121Y.

The cleaning blade 62Y includes a rectangular holder 621 made of a rigid material, such as a metal or a rigid plastic, and a rectangular elastic blade 622. The elastic blade 622 is fixed to an end portion of the holder 621 by adhesive or the like, and another end portion of the holder 621 is supported on a casing of the cleaning device 30 in the form of a cantilever.

As shown in FIG. 4, the elastic blade 622 is a laminated blade member including, as multiple layers, an edge layer 622b and a backing layer 622a. The edge layer 622b is a layer that forms a proximal edge portion which comes in contact with the photoconductor 10Y directly. The edge layer 622b is made of a urethane rubber material having a hardness greater than that of a urethane rubber material of the backing layer 622a. The edge layer 622b has a 100% modulus value greater than that of the backing layer 622a. As an example of the combination of the edge layer 622b and the backing layer 622a, a urethane rubber material having a 100% modulus value (23° C.) of 4-5 MPa is used to form the backing layer 622a while a urethane rubber material having a 100% modulus value (23° C.) of 6-7 MPa is used to form the edge layer 622b. However, a urethane rubber material having a 100% modulus value (23° C.) of 6 MPa or greater may be suitably used to form the edge layer 622b. Moreover, a urethane rubber material having a rubber hardness of 80 degrees (JISA) may be used to form the edge layer 622b, and a urethane rubber material having a rubber hardness of 70 degrees (JISA) may be used to form the backing layer 622a. The edge layer 622b has a thickness of 0.5 mm and the backing layer 622a has a thickness of 1.3 mm.

On the other hand, a cleaning blade according to the related art has been formed of a single layer and a urethane rubber material having a 100% modulus value (23° C.) of 5 MPa has been commonly used to form the proximal edge portion which is in contact with the photoconductor. If such a single-layer cleaning blade according to the related art is used in the process cartridge 121Y, the cleaning performance may easily fall and the quantity of the toner passing through the cleaning blade may be increased. For this reason, the stain of the charging roller 41Y becomes remarkable and it is difficult to obtain uniform electrostatic characteristics.

If a lubricant is applied to the photoconductor 10K in the K process cartridge 121K, the lubricant applied to the photoconductor 10K is transferred to the intermediate transfer belt 162. The lubricant transferred to the intermediate transfer belt 162 is further transferred to the photoconductor 10Y in the Y process cartridge 121Y which is located on the downstream side of the K process cartridge 121K in the moving direction of the intermediate transfer belt 162. The lubricant applying unit 70K of the K process cartridge 121K uniformly applies the lubricant to the photoconductor 10K in the main scanning direction by using the fur brush 71K. Hence, the amount of the lubricant transferred to the intermediate transfer belt 162 is affected by the presence of an image pattern, and the amount of the lubricant remaining on the intermediate transfer belt 162 becomes uneven. Because the amount of the lubricant remaining on the intermediate transfer belt 162 is uneven, the amount of the lubricant further transferred to the photoconductor 10Y of the Y process cartridge 121Y also becomes uneven, and the amount of the lubricant remaining on the photoconductor 10Y becomes uneven in either the main scanning direction or the sub-scanning direction. For this reason, the coefficient of friction of the surface of the photoconductor 10Y becomes uneven.

In the case of the cleaning blade according to the related art, the hardness of the proximal edge portion is too low, and deformation of the proximal edge portion when the photoconductor 10Y is rotated becomes too large. The amount of stick slip becomes relatively large, and the action of the nip portion (i.e., the contact portion between the photoconductor and the cleaning blade) becomes unstable. If the coefficient of friction of the photoconductor 10Y is uneven, the frictional force between the photoconductor 10Y and the cleaning blade is also uneven and the action of the nip portion becomes still more unstable. Hence, the contact pressure is not stabilized and the cleaning performance falls sharply.

In contrast, the edge layer 622b of the cleaning blade 62Y provided in the Y process cartridge 121Y according to the embodiment is made of the material having a high hardness, and the proximal edge portion coming in contact with the photoconductor 10Y has a high hardness. Thus, deformation of the proximal edge portion can be reduced, the action of the nip portion can be stabilized, and good cleaning performance can be provided. Accordingly, the stain of the charging roller 41Y is prevented by the provision of good cleaning performance. Even in the Y process cartridge 121Y using the charging roller 41Y to which only the DC voltage is supplied, the charging stability over an extended period of time can be provided.

If the material having a high hardness is used to form the cleaning blade of the single layer according to the related art, the action of the nip portion can be stabilized, but, over an extended period of time, the cleaning blade may be degraded and the contact pressure may be lowered, and the cleaning performance may fall. To obviate the problem, the cleaning blade 62Y according to the embodiment is formed of a laminated structure of the two layers, and the edge layer 622b which is relatively high in hardness and 100% modulus value and the backing layer 622a which is relatively low in hardness and 100% modulus value are used. Accordingly, the degradation of the cleaning blade and the lowering of the contact pressure over an extended period of time can be prevented. Thereby, good cleaning performance can be provided over an extended period of time. The charging stability over an extended period of time is obtained and high reliability and a long operating life of the Y process cartridge 121Y can be provided.

Further, a cleaning blade 62C and a cleaning blade 62M, which have the composition that is the same as that of the cleaning blade 62Y in the Y process cartridge 121Y, are respectively provided in the C process cartridge 121C and the M process cartridge 121C using the charging rollers 41C and 41M to which only the DC voltage is supplied. Thus, good cleaning performance can be provided, the stain of the charging rollers 41C and 41M is prevented, and charging stability is acquired also in the process cartridges 121C and 121M using the charging rollers 41C and 41M which are supplied with the DC voltage only. Thus, high reliability and a long operating life of the C process cartridge 121C and the M process cartridge 121M can be provided.

Next, the composition of the cleaning blade 62K provided in the K process cartridge 121K will be described.

The cleaning blade 62K provided in the K process cartridge 121K may have a composition that is different from the composition of the cleaning blades 62Y, 62C, and 62M provided in the Y, C, and M process cartridges 121Y, 121C, and 121M.

Similar to the cleaning blade 62Y, the cleaning blade 62K includes the rectangular elastic blade 622 which is a laminated blade member including, as multiple layers, the edge layer 622b and the backing layer 622a. However, the relationship in the rubber hardness between the edge layer 622b and the backing layer 622a in the cleaning blade 62K is reverse to that in the cleaning blade 62Y.

Specifically, in the cleaning blade 62K provided in the K process cartridge 121K, the edge layer 622b is made of a urethane rubber material having a hardness less than that of a urethane rubber material of the backing layer 622a. The edge layer 622b has a 100% modulus value smaller than that of the backing layer 622a. As an example of the combination of the edge layer 622b and the backing layer 622a, a urethane rubber material having a 100% modulus value (23° C.) of 3 MPa or greater is used to form the backing layer 622a while a urethane rubber material having a 100% modulus value (23° C.) of 2.5 MPa or less is used to form the edge layer 622b. Moreover, a urethane rubber material having a rubber hardness of 60 to 65 degrees (JISA) may be used to form the edge layer 622b, and a urethane rubber material having a rubber hardness of 70 to 75 degrees (JISA) may be used to form the backing layer 622a. The edge layer 622b has a thickness of 0.5 mm and the backing layer 622a has a thickness of 1.3 mm.

In the K process cartridge 121K according to the embodiment, the lubricant is uniformly applied to the surface of the photoconductor 10K. When compared with the color process cartridges 121Y, 121M, and 121C to which the lubricant is not applied, the action of the nip portion of the cleaning blade 62K can be easily stabilized. Thus, even if the rubber hardness of the edge layer 622b is not so high, the amount of stick slip of the edge layer 622b does not become large, the action of the blade edge is stabilized, and good cleaning performance can be easily obtained.

On the other hand, when compared with the color process cartridges 121Y, 121M, and 121C, the movement distance of the photoconductor of the K process cartridge 121K is long. Thus, high wear resistance of the cleaning blade is required for the K process cartridge 121K when compared with the color process cartridges 121Y, 121M, and 121C. Generally, it is known that, when the urethane rubber is used to form the cleaning blade, wear resistance of a cleaning blade made of a urethane rubber material having a low hardness is higher than that of a cleaning blade made of a urethane rubber material having a high hardness.

In the K process cartridge 121K, the edge layer 622b is formed of the urethane rubber material having a low hardness providing high wear resistance, a long operating life of the cleaning blade 62K and a long operating life of the process cartridge 121K can be provided. If the cleaning blade of a single layer is formed of a urethane rubber material having a low hardness and high wear resistance, blade curling may easily arise due to the use of the rubber material with the low hardness. To obviate the problem, the backing layer 622a is formed of the urethane rubber material having a hardness greater than that of the edge layer 622b and combined with the edge layer 622b, the hardness of the whole cleaning blade is increased and the occurrence of blade curling may be prevented.

As described above, in the printer 100 according to the embodiment, the K process cartridge 121K has the composition different from that of the three color process cartridges 121Y, 121C, and 121M. The K process cartridge 121K which is frequently used includes the charging roller 41K to which the AC superimposed voltage is supplied, and the lubricant applying unit 70K, and high reliability and a long operating life of the process cartridge can be provided. On the other hand, each of the three color process cartridges 121Y, 121C, and 121M includes the charging roller to which only the DC voltage is supplied, and the cleaning blade which allows the action of the edge part to be stabilized, and high reliability and a long operating life of the process cartridge can be provided. Accordingly, while the office environments are taken into consideration, the occurrence of charging sound and ozone can be prevented and the device enlargement and weight increase can be prevented. Further, good reliability and a long operating life of each of the process cartridges 121K, 121Y, 121C, and 121M can be provided and the consumption of unnecessary resources is prevented while the office environments are taken into consideration.

In the above-described embodiment, to improve the speed of the operation in the monochrome mode, the K process cartridge 121K among the four process cartridges 121Y, 121C, 121M, and 121K is arranged at a position nearest to the secondary transfer nip portion. However, the image forming device according to the invention is not limited to the above-described embodiment. Regardless of the position where the K process cartridge 121K is arranged, the image forming device according to the invention can be implemented while the same advantageous features as in the above-described embodiment can be provided.

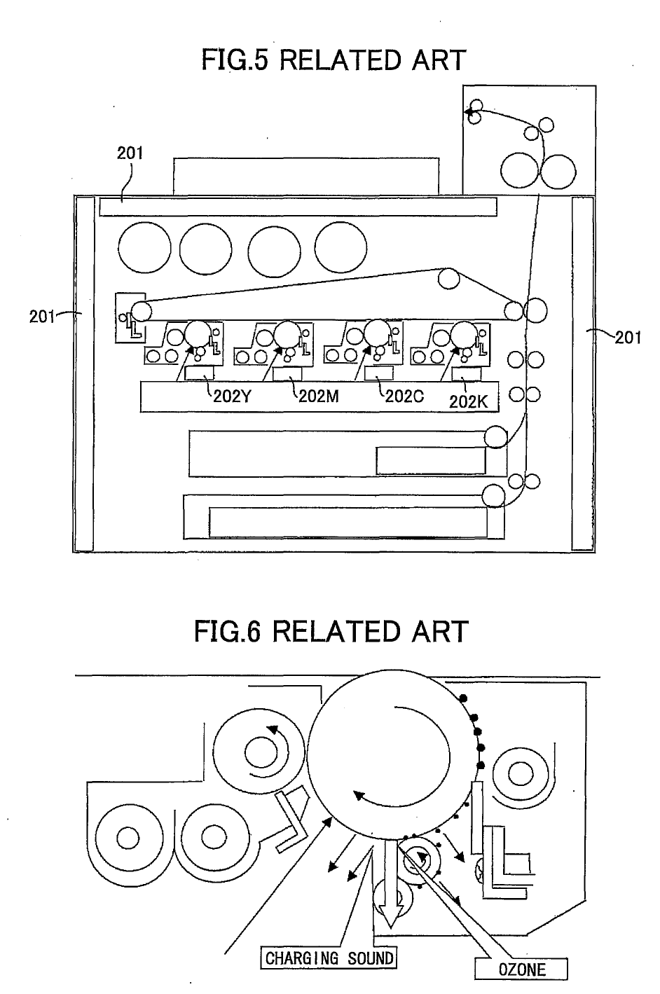

FIG. 5 is a schematic diagram showing a structure of a printer according to the related art as a comparative example. In the printer according to the related art, each of Y, C, M, and K process cartridges has the same composition except that the colors of toners stored in the process cartridges are different from each other. In the following, suffixes Y, C, M, and K representing members or components for yellow, cyan, magenta, and black colors, respectively, will be omitted.

FIG. 6 is a schematic diagram showing a structure of a process cartridge provided in the printer according to the related art. In a charging device in the process cartridge of FIG. 6, an AC superimposed voltage is supplied to a charging roller. When the printer according to the related art operates in the color mode, the AC superimposed voltage is supplied to all of the process cartridges simultaneously, and charging sound becomes loud and may turn into unusual noise. In addition, when the printer according to the related art operates in the color mode, the amount of ozone emerging from the printer according to the related art increases.

For this reason, it has been required that noise isolation components 201 are provided in the printer according to the related art, in order to prevent unusual noise from emanating from the printer. Further, in the printer according to the related art, it has been required that ozone processing units 202Y, 202C, 202M, and 202K, such as large-sized ozone filters or ozone exhaust passages, are attached to the process cartridges, respectively, in order to process abundant ozone. Hence, these measures cause device enlargement and weight increase.

As described above, the image forming device according to the embodiment includes a plurality of image formation units such as the process cartridges 121, each image formation unit including an image carrier such as the photoconductor 10, the charging device 40 being adapted to charge a surface of the image carrier, the developing device 50 being adapted to form a toner image on the image carrier surface, and the cleaning device 30 being adapted to remove residual toner on the image carrier surface, wherein the plurality of image formation units are arranged in parallel in a vicinity of the intermediate transfer belt 162 adapted to be rotated and transfer the toner image on the image carrier surface to a recording medium via the intermediate transfer belt 162, wherein the image forming device is adapted to selectively operate in one of a color mode in which the plurality of image formation units are operated to form a color image and a monochrome mode in which a single image formation unit is operated to form a monochrome image, wherein the image formation unit 121K operated in the monochrome mode includes the charging device having a charging member, such as the charging roller 41K, to which an AC superimposed voltage is supplied, and the lubricant applying unit 70K adapted to apply a lubricant to the image carrier, wherein the image formation units 121Y, 121M, and 121C operated only in the color mode include the charging devices having the charging members 41Y, 41M, and 41C to which the DC voltage is supplied, and the image formation unit 121Y arranged at a position nearest to and on a downstream side of the image formation unit 121K operated in the monochrome mode in the moving direction of the intermediate transfer belt includes the cleaning device 30Y having a blade member, such as the elastic blade 622, a proximal edge portion of the blade member is in contact with the surface of the image carrier to remove residual toner from the surface of the image carrier, and the proximal edge portion of the blade member is made of an elastic rubber having a 100% modulus value of 6 MPa or greater at 23° C. Thereby, the image forming device according to the embodiment may provide high reliability and a long operating life and may prevent the device enlargement and weight increase while taking into consideration the office environments.

Further, in the image forming device according to the embodiment, the elastic blade 622 is a laminated elastic blade having multiple layers, the multiple layers made of materials having mutually different 100% modulus values, respectively, and the edge layer 622b among the multiple layers includes the proximal edge portion and is made of a material having a 100% modulus value greater than that of another layer among the multiple layers, such as the backing layer 622a. Thereby, with the use of the edge layer 622b made of the material having the greater 100% modulus value, the stability of the nip portion may be maintained and good cleaning performance may be provided. Moreover, with the use of the backing layer 622a made of the material having the 100% modulus value smaller than that of the edge layer 622b, the degradation and the reduction of the contact pressure of the elastic blade over an extended period of time may be prevented. Thus, good cleaning performance may be provided over an extended period of time, and the stain of the charging member may be prevented over a long term. Accordingly, the charging stability may be provided over an extended period of time, and high reliability and a long operating life may be provided.

Further, in the image forming device according to the embodiment, the image formation unit used in the monochrome mode is a black toner image formation unit adapted to form a black toner image, and the black toner image formation unit is arranged at a most downstream position in the moving direction of the intermediate transfer member and nearest to an image transfer position to transfer the toner image from the intermediate transfer member to the recording medium among the plurality of image formation units. Thereby, the distance between the image formation unit to form a black toner image, such as the black process cartridge 121K, and the transporting passage of the transfer sheet is shortened, and the printing speed in the monochrome mode to form a monochrome image may be increased.

Further, in the image forming device according to the embodiment, the charging member of the charging device of each of the image formation units operated only in the color mode is arranged to be in contact with the image carrier. Thereby, the DC voltage is supplied to the charging member of the charging device of each of the image formation units operated only in the color mode, and the charging member is in contact with the image carrier. Thus, the amount of ozone emerging from the image forming device may be reduced.

Further, in the image forming device according to the embodiment, the charging member of the charging device of the image formation unit operated in the monochrome mode is arranged to be in contact with the image carrier. Thereby, the AC superimposed voltage is supplied to the charging member operated in the monochrome mode and the charging member is in contact with the image carrier. The charging current becomes high and the charging characteristics may be stabilized. Thus, high reliability and a long operating life of the image formation unit operated in the monochrome mode may be provided.

Further, in the image forming device according to the embodiment, the charging member of the charging device of the image formation unit operated in the monochrome mode is arranged to confront the image carrier with a gap between the charging member and the image carrier. Thereby, the AC superimposed voltage is supplied to the charging member operated in the monochrome mode and the charging member is not in contact with the image carrier. The stain of the charging member due to the residual toner on the image carrier may be prevented. Thus, high reliability and a long operating life of the image formation unit operated in the monochrome mode may be provided.

Further, in the image forming device according to the embodiment, the cleaning device of the image formation unit operated in the monochrome mode includes a laminated elastic blade having multiple layers, the multiple layers being made of materials having mutually different 100% modulus values, and an edge layer among the multiple layers includes a proximal edge portion and is made of a material having a 100% modulus value smaller than that of a material of another layer among the multiple layers. Thereby, the edge layer 622b is made of a rubber material having a relatively small 100% modulus value with high wear resistance, and a long operating life of the cleaning blade 62K and a long operating life of the process cartridge 121K may be provided. Moreover, the backing layer 622a is made of a rubber material having a hardness greater than that of the edge layer 622b, and the hardness of the whole cleaning blade is increased and the occurrence of blade curling may be prevented. Thus, high reliability and a long operating life of the image formation unit operated in the monochrome mode may be provided.

Further, in the image forming device according to the embodiment, the lubricant applying unit of the image formation unit operated in the monochrome mode is arranged at a position on a downstream side of the cleaning device in the rotating direction of the image carrier. Thereby, the application of the lubricant to the photoconductor may be stabilized. Thus, high reliability and a long operating life of the image formation unit operated in the monochrome mode may be provided.

Further, in the image forming device according to the embodiment, the lubricant applied by the lubricant applying unit contains at least one of a fatty acid metal salt and an inorganic lubricant. Thereby, the photoconductor surface may be maintained in an appropriate condition by the lubricant applied thereto. When the lubricant contains both the fatty acid metal salt and the inorganic lubricant, the fatty acid metal salt serves to prevent the photoconductor surface from being ruptured by the charging current. Moreover, the inorganic lubricant which is not ruptured by the charging current serves to maintain the lubricating action in a suitable state, which enables the cleaning performance of the photoconductor to be maintained at a desired level over an extended period of time.

Further, in the image forming device according to the embodiment, the fatty acid metal salt is zinc stearate and the inorganic lubricant is boron nitride. Thereby, zinc stearate as the fatty acid metal salt is excellent in the film formation property for the photoconductor, and good lubricity and a protection property may be provided for the photoconductor. Further, boron nitride as the inorganic lubricant is excellent in lubricity.

As described in the foregoing, the image forming device according to the invention may provide high reliability and a long operating life and prevent the device enlargement and weight increase while taking into consideration the office environments.

The image forming device according to the invention is not limited to the above-described embodiments, and variations and modifications may be made without departing from the scope of the present invention.

The present application is based upon and claims the benefit of priority of Japanese Patent Application No. 2012-270609, filed on Dec. 11, 2012, the contents of which are incorporated herein by reference in their entirety.

What is claimed is:

1. An image forming device comprising:
a plurality of image formation units, each of the plurality of image formation units including an image carrier, a charging device to charge a surface of the image carrier, a developing device to form a toner image on the image carrier surface, and a cleaning device to remove a residual toner on the image carrier surface;
wherein the plurality of image formation units are arranged in a line in a vicinity of an intermediate transfer member and transfer the toner image formed on the image carrier to a recording medium via the intermediate transfer member;
wherein the image forming device selectively operates in one of a color mode in which the plurality of image formation units are operated to form a color image and a monochrome mode in which a single image formation unit is operated to form a monochrome image;
wherein the image formation unit operated in the monochrome mode includes a lubricant applying unit to apply a lubricant to the image carrier and the charging device to supply a DC voltage superimposed with an AC voltage to the image carrier;
wherein each of the image formation units operated only in the color mode includes the charging device to supply a DC voltage to the image carrier, and one of the image formation units arranged at a position nearest to and on a downstream side of the image formation unit operated in the monochrome mode in a moving direction of the intermediate transfer member includes the cleaning device having a blade member in which a proximal edge portion of the blade member contacts the image carrier surface to remove a residual toner from the image carrier surface, and the proximal edge portion of the blade member is made of an elastic rubber having a 100% modulus value of 6 MPa or greater at 23° C.

2. The image forming device of claim 1,
wherein the blade member is a laminated elastic blade having multiple layers, the multiple layers being made of materials having mutually different 100% modulus values, respectively, and the multiple layers include first and second layers, the first layer including the proximal edge portion and made of a material having a 100% modulus value greater than that of the second layer.

3. The image forming device of claim 1,
wherein the image formation unit operated in the monochrome mode is a black toner image formation unit to form a black toner image, and the black toner image formation unit is arranged at a most downstream position in the moving direction of the intermediate transfer member and nearest to an image transfer position to transfer the toner image from the intermediate transfer member to the recording medium among the plurality of image formation units.

4. The image forming device of claim 1,
wherein, in each of the image formation units operated only in the color mode, a charging member of the charging device contacts the image carrier.

5. The image forming device of claim 1,
wherein, in the image formation unit operated in the monochrome mode, a charging member of the charging device contacts the image carrier.

6. The image forming device of claim 1,
wherein, in the image formation unit operated in the monochrome mode, a charging member of the charging device confronts the image carrier with a gap between the charging member and the image carrier.

7. The image forming device of claim 1,
wherein, in the image formation unit operated in the monochrome mode, the cleaning device includes a laminated elastic blade having multiple layers, the multiple layers being made of materials having mutually different 100% modulus values, and the multiple layers include first and second layers, the first layer including a proximal edge portion and made of a material having a 100% modulus value smaller than that of the second layer.

8. The image forming device of claim 1,
wherein, in the image formation unit operated in the monochrome mode, the lubricant applying unit is arranged at a downstream position of the cleaning device in a rotating direction of the image carrier.

9. The image forming device of claim 1,
wherein the lubricant contains at least one of a fatty acid metal salt and an inorganic lubricant.

10. The image forming device of claim 9,
wherein the fatty acid metal salt is zinc stearate, and the inorganic lubricant is boron nitride.
